(19) United States
(12) Patent Application Publication
(10) Pub. No.: US 2025/0371376 A1
(43) Pub. Date: Dec. 4, 2025

(54) UNSUPERVISED RELEVANCY SIEVE FOR LOG DATA

(71) Applicant: Cisco Technology, Inc., San Jose, CA (US)

(72) Inventors: Timo Köhler, Gera (DE); Frank Brockners, Köln (DE); Marco Trinelli, Lausanne (CH); Shaja Arul Selvamani, San Jose, CA (US)

(73) Assignee: Cisco Technology, Inc., San Jose, CA (US)

(21) Appl. No.: 19/091,074

(22) Filed: Mar. 26, 2025

Related U.S. Application Data
(60) Provisional application No. 63/654,378, filed on May 31, 2024.

(51) Int. Cl. G06N 5/01

(52) U.S. Cl. CPC G06N 5/01

(57) ABSTRACT

In one implementation, a device may generate cleaned log messages by removing irrelevant data from log messages. The device may construct a directed root tree graph for the cleaned log messages. The device may refine the cleaned log messages in the directed root tree graph based on predefined relationships established in the directed root tree graph. The device may select representative messages from the cleaned log messages in the directed root tree graph to generate a relevancy-filtered file configured for inclusion in a language model prompt.

### RELATED APPLICATION

This application claims priority to U.S. Prov. Appl. Ser. No. 63/654,378, filed May 31, 2024, for UNSUPERVISED RELEVANCY SIEVE FOR LOG DATA, by Köhler, et al., the contents of which are incorporated herein by reference.

### TECHNICAL FIELD

The present disclosure relates generally to computer networks and more particularly to an unsupervised relevancy sieve for log data.

### BACKGROUND

Analyzing log files is critical for information technology (IT) operations and systems management, as it allows engineers to monitor system behavior, identify issues, and ensure smooth functioning. However, the volume and complexity of log data present significant challenges. As log files grow larger and more complex, sifting through them manually or using traditional methods becomes increasingly impractical. Concurrently, the rise of language models, such as large language models (LLMs), has opened new avenues for automating and enhancing the analysis of various types of data due to their advanced reasoning and contextual understanding capabilities.

Despite their potential, current language models face significant limitations when used to analyze log files. First, the sheer size of a typical log file often exceeds the context window of language models, preventing them from processing the entire file effectively. Second, existing methods to reduce the size of log files tend to filter out information that is not deemed anomalous, but doing so misses out on retaining all relevant data necessary for a comprehensive analysis. Third, language models require high-quality, relevant data to perform meaningful analysis, but current preprocessing techniques fail to provide this efficiently. These constraints hinder the effective utilization of language models for purposes of log file analysis.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of an architecture utilizing an unsupervised relevance sieve for log data;

FIG. 5 illustrates and example of an architecture including an unsupervised relevancy sieve;

FIG. 6 illustrates and example of an architecture for utilizing an unsupervised relevance sieve to perform relevancy filtering on log-data;

FIG. 7 illustrates an example of a cleaning process;

FIGS. 8A-8C illustrate an example of a directed root tree of tokenized logging data generated by an unsupervised relevance sieve;

FIG. 9 illustrates an example of data sampling the most recent tail-end node attributes from the annotated directed root tree; and

FIG. 10 illustrates an example of a simplified procedure for implementing an unsupervised relevancy sieve for log data, in accordance with one or more implementations described herein.

### DESCRIPTION OF EXAMPLE IMPLEMENTATIONS

### Overview

According to one or more implementations of the disclosure, a device may generate cleaned log messages by removing irrelevant data from log messages. The device may construct a directed root tree graph for the cleaned log messages. The device may refine the cleaned log messages in the directed root tree graph based on predefined relationships established in the directed root tree graph. The device may select representative messages from the cleaned log messages in the directed root tree graph to generate a relevancy-filtered file configured for inclusion in a language model prompt.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

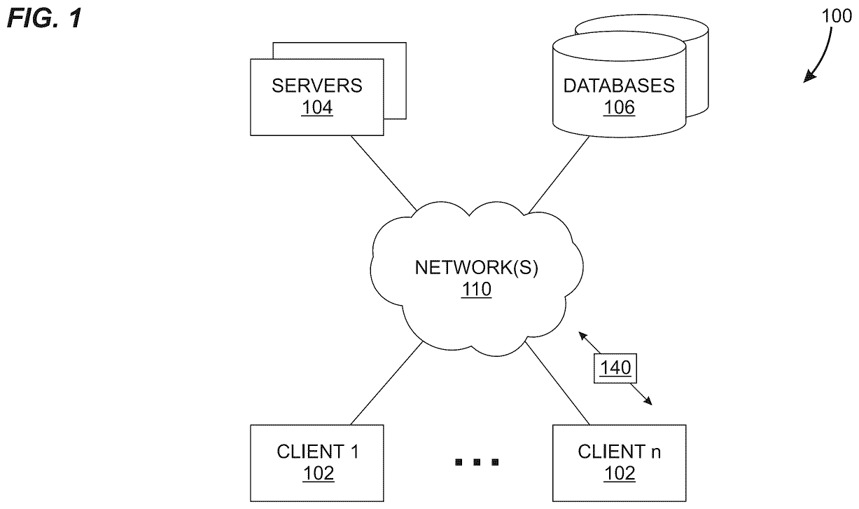

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

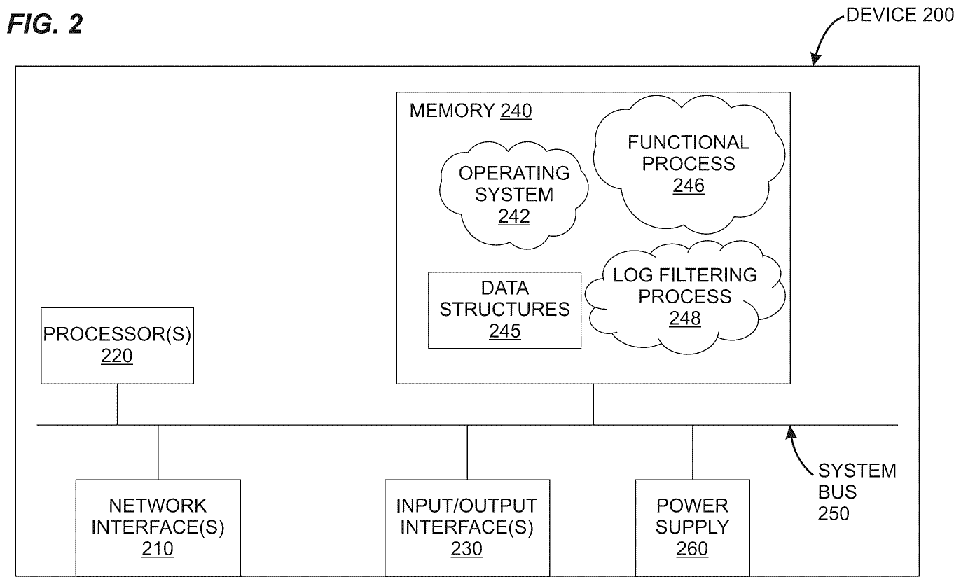

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs (e.g., computer-executable instructions) and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an illustrative process such as log filtering process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, log filtering process 248 may include computer executable instructions that, when executed by processor 220, cause device 200 to perform the techniques described herein. To do so, in some implementations, log filtering process 248 may utilize and/or be a component of machine learning implementations. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, log filtering process 248 may employ and/or be utilized to handle prompts to and/or access of one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that log filtering process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, log filtering process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of configuring an observability platform to perform certain application analytics, log filtering process 248 may be a component of, use, and/or be utilized in the management of prompts/access to a generative model to generate configurations or other outputs based on a conversational input from a user (e.g., voice, text, etc.). In another example, log filtering process 248 may utilize a generative model with a method invocation data collector (MIDC) to assist in automated or manual identification of transactional attributes for spans. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

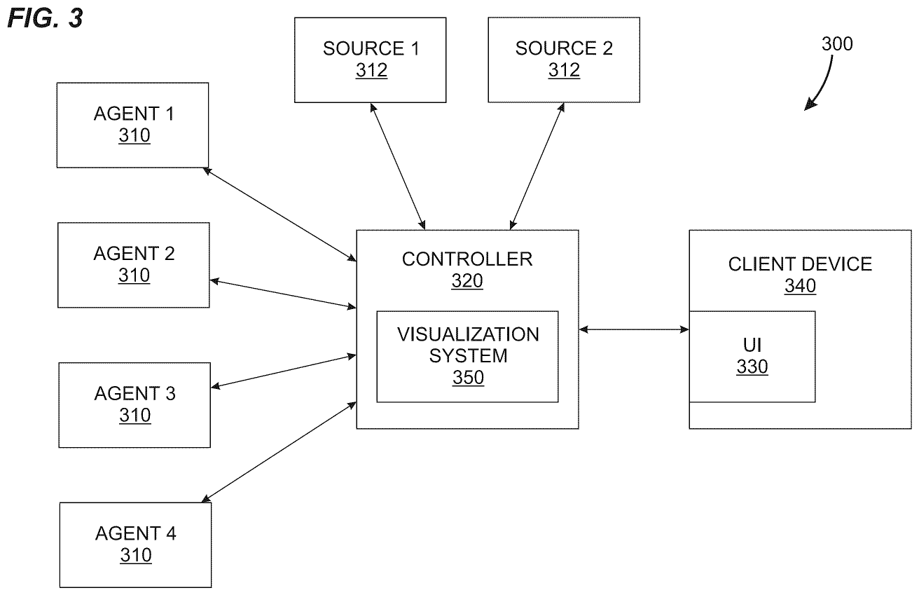

FIG. 3 is a block diagram of an example of an observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (e.g., agents 310), one or more sources (e.g., sources 312), and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a user interface 330 (denoted UI in FIG. 3), such as a browser-based UI, that is the primary interface for monitoring, analyzing, and troubleshooting the monitored environment. Specifically, the controller 320 can receive data from agents 310, sources 312 (and/or other coordinator devices), associate portions of data (e.g., topology, transaction end-to-end paths and/or metrics, etc.), communicate with agents to configure collection of the data (e.g., the instrumentation/tests to execute), and provide performance data and reporting through user interface 330. User interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller 320 may be installed locally and self-administered.

The controllers 320 receive data from the agents 310 (e.g., Agents 1-4) and/or sources 312 deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application. Further, the controllers 320 can receive data from sources 312 (e.g., sources 1-2). Any of the sources can be implemented to provide various types of observability data that can include information, metrics, telemetry data, business data, network data, etc.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be implemented as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

An application transaction, in particular, is a representation of the particular service provided by the monitored environment that provides a view on performance data in the context of the various tiers that participate in processing a particular request. That is, an application transaction, which may be identified by a unique application transaction identification (ID), represents the end-to-end processing path used to fulfill a service request in the monitored environment (e.g., adding items to a shopping cart, storing information in a database, purchasing an item online, etc.). Thus, an application transaction is a type of user-initiated action in the monitored environment defined by an entry point and a processing path across application servers, databases, and potentially many other infrastructure components. Each instance of an application transaction is an execution of that transaction in response to a particular user request (e.g., a socket call, illustratively associated with the TCP layer). An application transaction can be created by detecting incoming requests at an entry point and tracking the activity associated with request at the originating tier and across distributed components in the application environment (e.g., associating the application transaction with a 4-tuple of a source IP address, source port, destination IP address, and destination port). A flow map can be generated for an application transaction that shows the touch points for the application transaction in the application environment. In one implementation, a specific tag may be added to packets by application specific agents for identifying application transactions (e.g., a custom header field attached to a hypertext transfer protocol (HTTP) payload by an application agent, or by a network agent when an application makes a remote socket call), such that packets can be examined by network agents to identify the application transaction identifier (ID) (e.g., a Globally Unique Identifier (GUID) or Universally Unique Identifier (UUID)). Performance monitoring can be oriented by application transaction to focus on the performance of the services in the application environment from the perspective of end users. Performance monitoring based on application transactions can provide information on whether a service is available (e.g., users can log in, check out, or view their data), response times for users, and the cause of problems when the problems occur.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or application transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be implemented across multiple devices, on different devices, utilizing additional devices, and so on, and the views shown herein are merely simplified examples that are not meant to be limiting to the scope of the present disclosure.

As noted above, IT/operations engineers have started to use language models (e.g., large language models (LLMs)) to help them analyze syslog files—for insight, classification, or reasoning tasks. In many cases, the size of the syslog file to be analyzed is larger than the context window of the language model used. These constraints hinder the effective utilization of language models in log file analysis. These limitations to utilizing language modes for log file analysis result in significant practical challenges, including extended system downtime, high computational resource demands, incomplete data analysis, delayed security breach detection, and/or poor user experiences.

### —Unsupervised Relevancy Sieve for Log Data—

In contrast, the techniques described herein introduce an unsupervised relevancy sieve that addresses these issues by efficiently filtering log files to retain only relevant information, accelerating analysis, reducing resource requirements, enhancing accuracy, and/or enabling faster threat/root cause detection. This may facilitate more reliable operations, better decision making, and/or and improved customer satisfaction.

Illustratively, the techniques described herein may be performed by hardware, software, and/or firmware, such as in accordance with log filtering process 248, which may include computer executable instructions executed by the processor 220 (or independent processor of interfaces 210) to perform functions relating to the techniques described herein.

Specifically, according to various implementations, a device may generate cleaned log messages by removing irrelevant data from log messages. The device may construct a directed root tree graph for the cleaned log messages. The device may refine the cleaned log messages in the directed root tree graph based on predefined relationships established in the directed root tree graph. The device may select representative messages from the cleaned log messages in the directed root tree graph to generate a relevancy-filtered file configured for inclusion in a language model prompt.

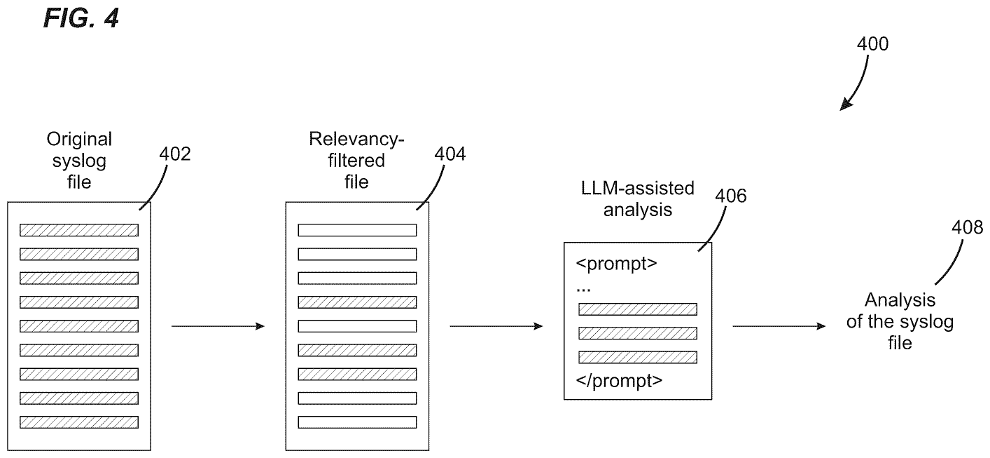

Operationally, FIG. 4 illustrates an example of an architecture 400 utilizing an unsupervised relevance sieve (URS) for log data. The URS may be an apparatus and/or a computer program (e.g., a tangible, non-transitory, computer-readable medium storing program instructions that cause a device to execute a process) which carries out specific tasks related to the unsupervised modification of original syslog files to arrive at a language model compliant format while retaining/including all relevant information for analysis of the syslog file.

As previously noted, IT/operations engineers have started to use language models to help them analyze syslog files. However, in many cases, the size of the syslog file to be analyzed is larger than the context window of an available language model. Also using language model prompts with fewer context tokens may result in a better language model prediction and reasoning performance. Therefore, retaining only relevant information in the context of the language model prompt may result in a better prediction score.

In architecture 400, the URS may be utilized to modify (e.g., reduce, etc.) the size of the syslog file in an unsupervised way, so that it fits the size of the context model of a language model. The URS may do so without losing “relevant information” (e.g., the information contained in the file that describes the behavior of the system) in the modification. For example, the relevant information may be information that describes the state of the system or entity that generated the log file.

Unlike “log anomaly” detectors proposed in the literature, the URS may not be configured to retrieve only anomalous events (e.g., “surprising messages” as information theory would call them) from the log file. Instead, the URS may be configured to increase the signal-to-noise ratio in the data and extract all the important signals in the data by filtering recurring and similar data with no relevant information. The retrieved “relevant data” may then be utilized for analysis, to identify anomalous events, predict root causes, etc. For example, the relevant data could be for anomaly detection, to create bootstrapping prompts for language model-based inference tasks, for classification or statistical purposes, etc.

In general, the described techniques may facilitate a computationally efficient filtering method to identify “relevant messages” in log files among large volumes of unimportant messages, and to condense them into a small output dataset with high information value. For instance, in architecture 400, an original syslog file 402 may be obtained. The URS may modify the original syslog file 402 to generate a relevancy-filtered file 404. The relevancy-filtered file 404 may be provided as a portion of a prompt 406 to a language model for language model-assisted prompt analysis. That is, the prompt 406 may be utilized for language model-assisted analysis yielding (e.g., directly, indirectly, in concert with anomaly detection utilities, etc.) an analysis of the syslog file 408.

In addition, the techniques described herein may perform these modification operations in an unsupervised manner (e.g., without the need for pre-training or fine-tuning). The content and semantics of syslog files are often domain specific. Events described in syslog data can be non-deterministic and difficult to classify. Balanced and comprehensive data sets for fine-tuning are rarely available in real-world deployments.

These techniques may leverage semantic relationships in log data. For example, methods that exploit semantic relationships in the log data may be leveraged to show better results than simple statistical methods based on e.g., token frequencies.

The techniques may fit the output of the method to a given maximum size. The maximum size of the context windows of language models varies. Consequently, the size of the output of the relevance filter may be adjustable.

These techniques may be configured to offer compute efficient log modifications by traversing the tree and comparing attributes to identify identical or similar entries. Often, filtering relevant information from large log files often needs to be done at the point where the data is generated. In many cases, these are edge devices with limited computing resources.

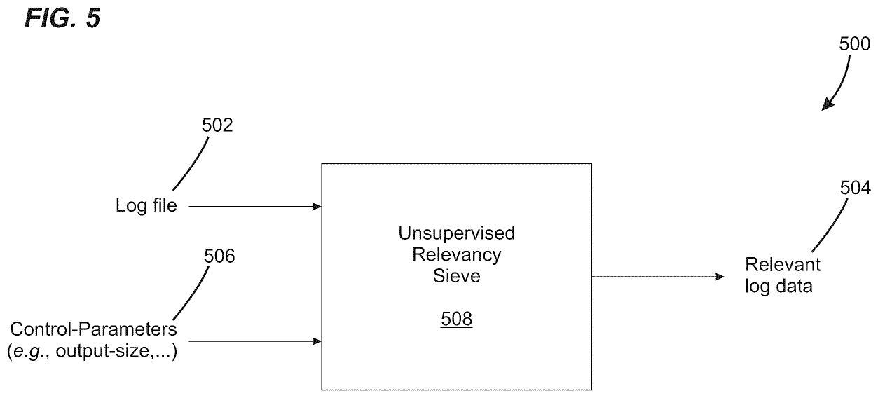

FIG. 5 illustrates and example of an architecture 500 including an unsupervised relevancy sieve (URS 508). Here, the URS 508 obtains a log file 502 and/or a set of parameters 506 as inputs. The URS 508 processes/operates on these inputs to produce relevant log data 504. Relevant log data 504 may include an output file containing, in some instances, only relevant information from the input log file. The URS 508 may not itself be an anomaly detector.

The URS 508 may differ from typical log analyzers that focus on anomaly detection in that it may functionally operate to combine comprehensive retrieval of all relevant information from a file, fully unsupervised operation, and/or utilization of semantic dependencies in the data. With respect to the comprehensive retrieval of all relevant information from a file, URS 508 may operate different from anomaly detectors that try to find what information theory calls “surprise messages” (e.g., the core idea of information theory is that the “informational value” of a communicated message depends on the degree to which the content of the message is surprising).

With respect to fully unsupervised operations, URS 508 may differ from protocol anomaly detectors that use embeddings. Those approaches typically rely on training data to classify an embedded vector as anomalous. Being fully unsupervised also may mean that there is no need for custom templating to parse the logs-many solutions rely on Drain as a log parser, which relies on human-defined template definitions. With respect to the utilization of semantic dependencies in the data, this may distinguish URS 508 from simple statistical methos that utilize word counts, token frequencies, etc.

The URS 508 may utilize one or more of a variety of inputs. One such input, as mentioned above, may include a log file 502. Log file 502 may be a file that contains logs from an entity, like a process, a device (e.g., a router or host), and/or an entire system. In addition, URS 508 may obtain a set of parameters 506 as inputs. The set of parameters 506 may include control-parameters.

The control parameters may be an optional set of parameters that control the behavior of the URS 508. Some of these parameters might only apply to the specific implementations of an URS 508 described further below. Some examples of control parameters may include the maximum size of the output file (e.g., to ensure that the output fits into the context window of a language model), a maximum number of samples retrieved from each tail node attribute list (e.g., see below for additionally details).

The URS 508 may process these inputs to produce a URS output. The URS output includes a subset of the data that was contained in the input log file (e.g., log file 502) which represents the “relevant information” contained in the log file 502.

For example, consider a scenario where a system generates logs for both regularly scheduled database backups and unscheduled service interruptions. The “relevant information” would include the successful completion of scheduled backups and any errors associated with these processes. In contrast, an anomaly might be an unscheduled and unexplained service interruption that deviates from the norm.

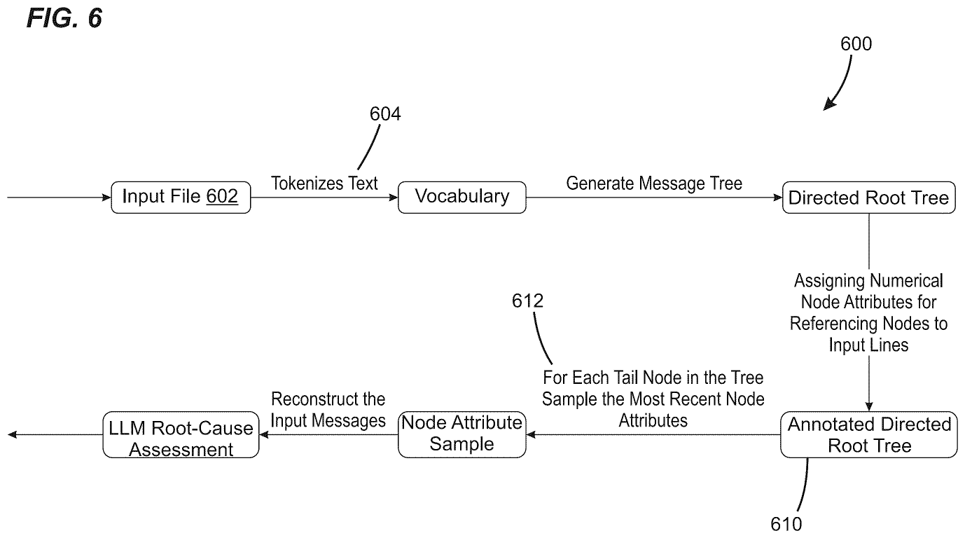

FIG. 6 illustrates and example of an architecture 600 for utilizing an unsupervised relevance sieve (URS) to perform relevancy filtering on log data. As previously discussed, the URS may operate on an input file 602. The input file 602 may include log data. With respect to the nature of log data, system logs can contain “relevant messages” with high informational value for the user. However, they may also include a lot of “noise.”

Logs may be generated in various styles and configurations by different log handlers. Generally, their common characteristics may include that they are single line messages, they have a well-defined structure per generating process, they have context-free grammar, and/or that messages are issued with predefined severity and content, periodically or deterministically. In addition, their common characteristics may include that device failures or program errors are non-deterministic, occurring only occasionally or sporadically, independent of the program input or hardware, that non-deterministic issues occur with low probability (see MTBF), and/or that non-deterministic issues are very expensive for the user and vendor to detect and to solve. Further, deterministic programs can generate high volumes of messages with high probability but low informational value. The signal-to-noise ratio can therefore be very small, which makes it difficult to detect the low probability/high value messages.

Many of an entity's log message are typically like each other. The basic configuration of the relevancy filter may be to collect all messages that are similar into a single branch or sub-branch of the rooted message tree, to select a few messages from each branch as representatives of the entire branch, and/or to add them to the output file.

In various implementations, URS may implement this configuration by utilizing a set of processing steps. The processing steps may include a clean up step. The clean up step may include the cleaning up and tokenizing 604 of each log message. This may involve the removal of numeric and/or special characters. Many log messages differ only in these special characters and numbers- or in other words, numbers and special characters may add a lot of entropy to the system.

The processing steps also includes the construction of an annotated and rooted message tree 610. A directed root tree graph-based method for deduplicating and filtering log messages can be described as a structured, hierarchical approach that organizes, and processes log data based on predefined relationships, as opposed to the statistical or probability-based grouping typical of unsupervised clustering algorithms.

Logs may be organized in a tree structure where each node represents a specific token, and relationships between nodes represent hierarchical or sequential dependencies (e.g., parent-child relationships). Each log message may be placed in the tree based on attributes such as timestamps, line number, message type, or other key features.

Messages may be filtered by traversing the tree and comparing attributes to identify identical or similar entries and by pruning branches or leaves that don't meet specific criteria, such as timestamp. The method may be deterministic and attribute-driven and may rely on predefined attributes (e.g., timestamps, message keys, etc.) and logical relationships to categorize and filter logs, ensuring deterministic and repeatable results.

Furthermore, the processing steps may include a selection step. The selection step may include selecting representative message tree branches. This may include random or deterministic attribute-based selection 612 of a small sample of data from each of the tail-end nodes in the tree. The hierarchical structure may allow for efficient sampling, such as retrieving the most recent logs from leaf nodes or consolidating messages from a specific subtree. This approach may ensure a consistent and deterministic feature selection across files while minimizing the noise when an input log file is processed.

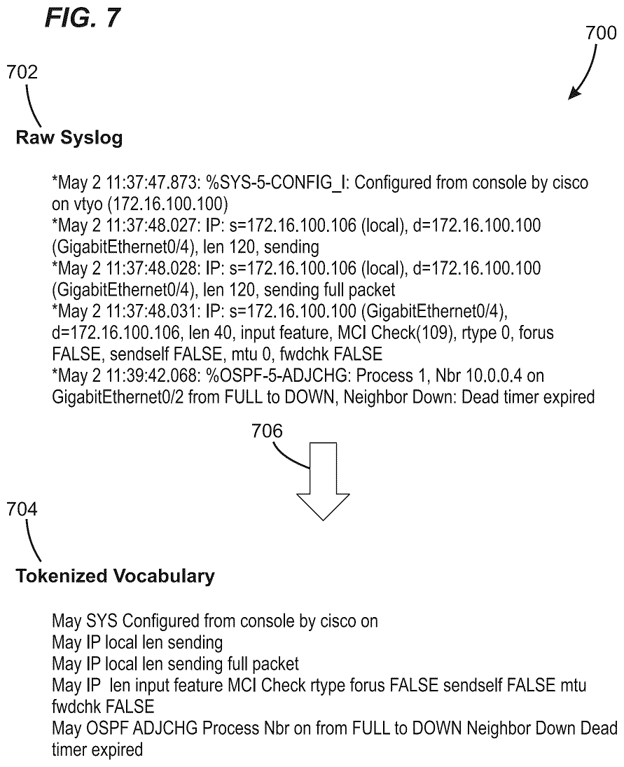

FIG. 7 illustrates an example of a cleaning process 700. In cleaning process 700, each logging message may be cleaned up and/or tokenized, such as by removing numeric and special characters. For example, input 702 (e.g., a raw syslog) may be subjected to cleanup and/or tokenization 706 to generate output 704.

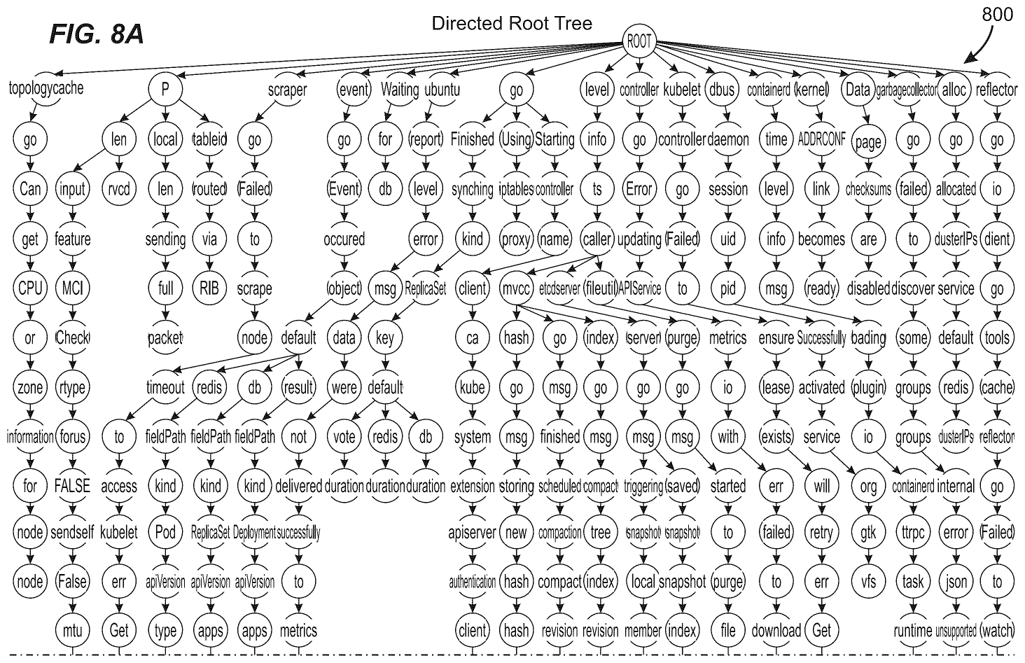

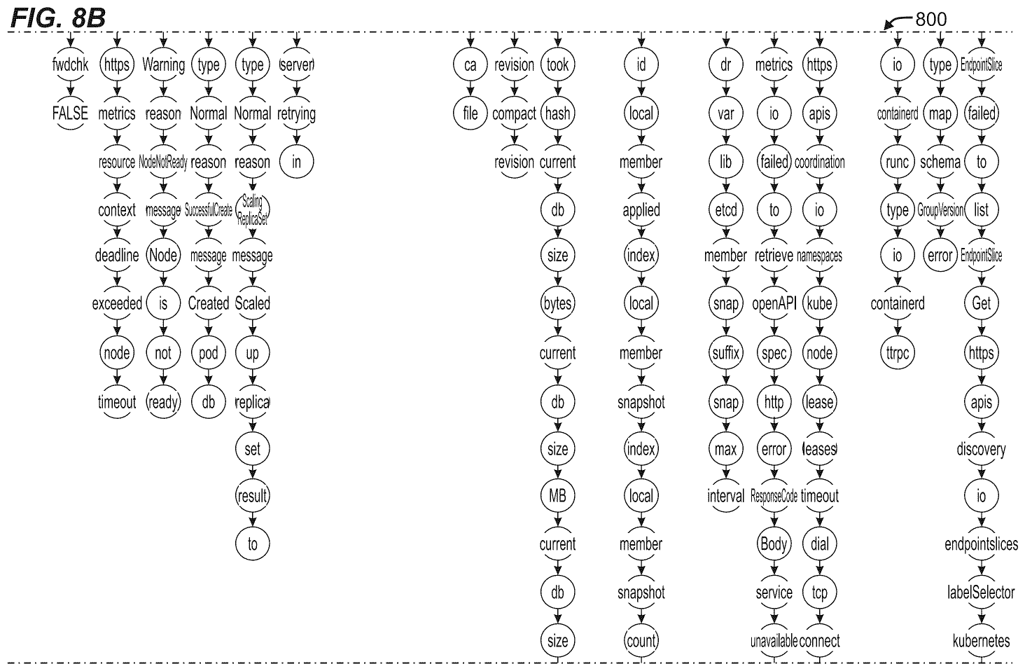

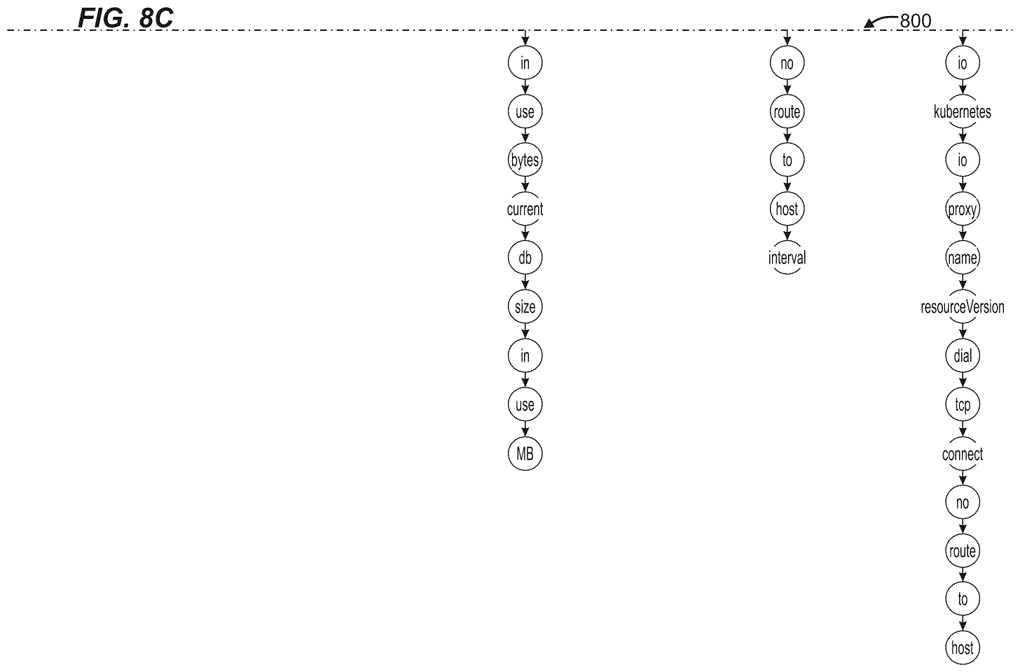

FIGS. 8A-8C illustrates an example of annotated and directed message tree 800 generated by a URS. The tree structure provides a clear, visualizable hierarchy of how log messages are grouped and filtered, making the method highly interpretable. The directed root tree graph-based method may be more structured, deterministic, and interpretable, making it well-suited for domain-specific log deduplication and filtering tasks.

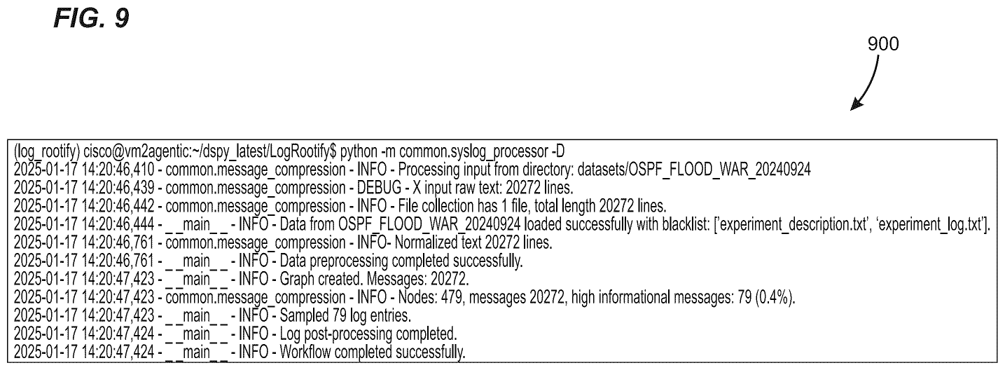

FIG. 9 illustrates an example of a URS generation of data samples 900 from a large input file including all preprocessing and postprocessing steps. In contrast to probability or clustering based methods, the URS approach using a directed root tree graph-based method ensures that every input message is preserved within the tree structure, so there is no risk of losing or ignoring data. Even outliers or unique messages that do not fit typical patterns are retained in the tree, possibly as their own nodes or leaves.

Such URS output messages may have a high “information value” because they communicate the occurrence of a very low probability event, given the number of input messages in the logging data collection. By collecting a small sample from each leaf node, the resulting dataset can be reduced in size by factors depending on the ratio of the number of high-probability to low-probability messages.

With respect to runtime and space requirements, the overall time complexity for insertion (tree creation) may be O(n*h), where h is the height of the tree and n is the number of input logging messages. For traversal the complexity may be O(n) for deduplication, filtering, or sampling.

By keeping the tree height h balanced and applying efficient traversal techniques, the directed root tree graph-based method can maintain competitive performance while ensuring deterministic results and data completeness.

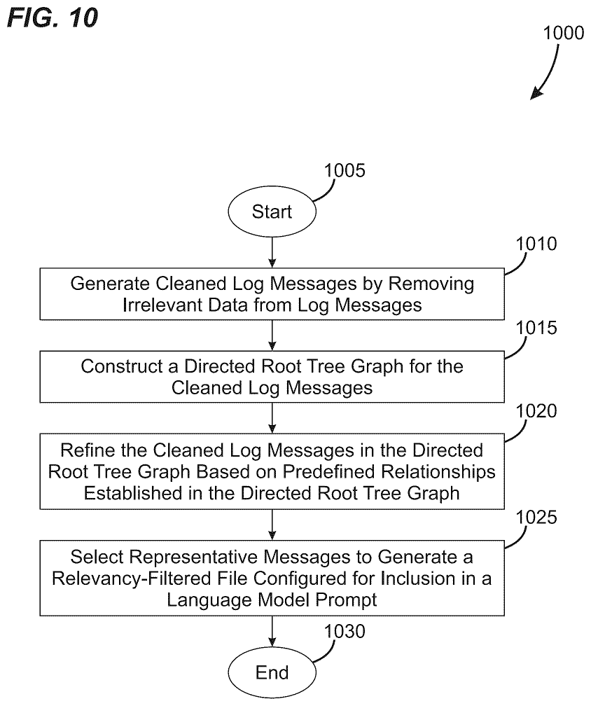

FIG. 10 illustrates an example of a simplified procedure for implementing an unsupervised relevancy sieve for log data, in accordance with one or more implementations described herein. For example, a non-generic, specifically configured device (e.g., device 200), may perform procedure 1000 (e.g., a method) by executing stored instructions (e.g., log filtering process 248).

The procedure 1000 may start at step 1005, and continues to step 1010 where, as described in greater detail above, the device (e.g., a controller, processor, etc.) may generate cleaned log messages by removing irrelevant data from log messages. Generating the cleaned log messages may include tokenizing the log messages. Further, removing the irrelevant data from the log messages may include normalizing text of the log messages by removing numeric and special characters.

At step 1015, as detailed above, a device may construct a directed root tree graph for the cleaned log messages. The directed root tree graph may be configured as an annotated directed root tree graph constructed by assigning numerical node attributes for referencing nodes to input lines. The directed root tree graph may be configured such that each node in the directed root tree graph represents a specific token, and relationships between nodes represent hierarchical or sequential dependencies.

Constructing the directed root tree graph for the cleaned log messages may include placing each of the cleaned log messages in the directed root tree graph based on corresponding attributes. These attributes may include a timestamp, a line number, a message type, a message key, and/or any other attribute of a corresponding log message.

At step 1020, as detailed above, a device may refine the cleaned log messages in the directed root tree graph. The refinement may proceed based on predefined relationships established in the directed root tree graph. Refining the cleaned log messages may include traversing the directed root tree graph and filtering log messages based on their corresponding attributes. Messages may be filtered by traversing the tree and comparing attributes to identify identical or similar entries and by pruning branches or leaves that don't meet specific criteria, such as timestamp. The method may be deterministic and attribute-driven and may rely on predefined attributes (e.g., timestamps, message keys, etc.) and logical relationships to categorize and filter logs, ensuring deterministic and repeatable results.

At step 1025, as detailed above, the device may select representative messages from the cleaned log messages in the directed root tree graph. These selected representative messages may be utilized to generate a relevancy-filtered file configured for inclusion in a language model prompt. In various implementations, the relevancy-filtered file may be provided to a language model configured for anomaly detection among log files.

The selection step may include selecting representative message tree branches. Selecting the representative messages may include sampling a most recent node attribute for each tail node in the directed root tree graph. Further, selecting the representative messages may include consolidating messages from a specific subtree of the directed root tree graph.

Procedure 1000 then ends at step 1030.

It should be noted that while certain steps or components described herein may be optional as described above, the steps and components shown are merely examples for illustration, and certain other steps may be included or excluded as desired. Further, while a particular order or arrangement of the steps and component is shown, this ordering is merely illustrative, and any suitable arrangement of the steps may be utilized without departing from the scope of the implementations herein.

The techniques described herein, therefore, introduce a fully automated and unsupervised apparatus that takes a log file and a set of parameters as input and produces an output containing a reduced set of information, which is bound to the context limits of a language model, but with a higher degree of relevancy, compared to the input log file. This information enrichment step may facilitate generating of the context information when constructing a language model query prompt. By efficiently filtering log files to retain only relevant information, these techniques may accelerate analysis, reduce resource requirements, enhance accuracy, and/or enable faster threat/root cause detection. This may facilitate more reliable operations, better decision making, and/or and improved customer satisfaction.

While there have been shown and described illustrative implementations that provide unsupervised relevancy sieves for log data, it is to be understood that various other adaptations and modifications may be made within the spirit and scope of the implementations herein. For example, while certain implementations are described herein with respect to using certain elements, modules, components, architectures, etc. for the purposes of providing unsupervised relevancy sieves for log data, the elements, modules, components, architectures, etc. are not limited as such and may be used for other functions, in other arrangements, in other functional distributions, in other implementations, etc.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
generating, by a device, cleaned log messages by removing irrelevant data from log messages;
constructing, by the device, a directed root tree graph for the cleaned log messages;
refining, by the device, the cleaned log messages in the directed root tree graph based on predefined relationships established in the directed root tree graph; and
selecting, by the device, representative messages from the cleaned log messages in the directed root tree graph to generate a relevancy-filtered file configured for inclusion in a language model prompt.

2. The method of claim 1, wherein removing the irrelevant data from the log messages includes normalizing text of the log messages by removing numeric and special characters.

3. The method of claim 1, wherein the directed root tree graph is an annotated directed root tree graph constructed by assigning numerical node attributes for referencing nodes to input lines.

4. The method of claim 1, further comprising:
providing the relevancy-filtered file to a language model configured for anomaly detection among log files.

5. The method of claim 1, wherein each node in the directed root tree graph represents a specific token, and relationships between nodes represent hierarchical or sequential dependencies.

6. The method of claim 1, wherein constructing the directed root tree graph for the cleaned log messages includes placing each of the cleaned log messages in the directed root tree graph based on corresponding attributes including at least one of a timestamp, a line number, a message type, or a message key.

7. The method of claim 6, wherein refining the cleaned log messages includes traversing the directed root tree graph and filtering log messages based on their corresponding attributes.

8. The method of claim 6, wherein selecting the representative messages includes sampling a most recent node attribute for each tail node in the directed root tree graph.

9. The method of claim 6, wherein selecting the representative messages includes consolidating messages from a specific subtree of the directed root tree graph.

10. The method of claim 1, wherein generating the cleaned log messages further comprises tokenizing the log messages.

11. An apparatus, comprising:
one or more network interfaces to communicate with a network;
a processor coupled to the one or more network interfaces and configured to execute one or more processes; and
a memory configured to store a process that is executable by the processor, the process, when executed, configured to:
generate cleaned log messages by removing irrelevant data from log messages;
construct a directed root tree graph for the cleaned log messages;
refine the cleaned log messages in the directed root tree graph based on predefined relationships established in the directed root tree graph; and
select representative messages from the cleaned log messages in the directed root tree graph to generate a relevancy-filtered file configured for inclusion in a language model prompt.

12. The apparatus as in claim 11, wherein the irrelevant data is removed from the log messages by normalizing text of the log messages by removing numeric and special characters.

13. The apparatus as in claim 11, wherein the directed root tree graph is an annotated directed root tree graph constructed by assigning numerical node attributes for referencing nodes to input lines.

14. The apparatus as in claim 11, the process further configured to:
provide the relevancy-filtered file to a language model configured for anomaly detection among log files.

15. The apparatus as in claim 11, the process further configured to:
configure the directed root tree graph so that each node in the directed root tree graph represents a specific token, and relationships between nodes represent hierarchical or sequential dependencies.

16. The apparatus as in claim 11, wherein the directed root tree graph for the cleaned log messages is constructed by placing each of the cleaned log messages in a directed root tree graph format based on corresponding attributes including at least one of a timestamp, a line number, a message type, or a message key.

17. The apparatus as in claim 16, wherein the cleaned log messages are refined by traversing the directed root tree graph and filtering log messages based on their corresponding attributes.

18. The apparatus as in claim 16, wherein selection of the representative messages includes sampling a most recent node attribute for each tail node in the directed root tree graph.

19. The apparatus as in claim 16, wherein selection of the representative messages includes consolidating messages from a specific subtree of the directed root tree graph.

20. A tangible, non-transitory, computer-readable medium storing program instructions that cause a device to execute a process comprising:
generating cleaned log messages by removing irrelevant data from log messages;
constructing a directed root tree graph for the cleaned log messages;
refining the cleaned log messages in the directed root tree graph based on predefined relationships established in the directed root tree graph; and
selecting representative messages from the cleaned log messages in the directed root tree graph to generate a relevancy-filtered file configured for inclusion in a language model prompt.
